(19) United States
(12) Patent Application Publication
(10) Pub. No.: US 2020/0167659 A1
(43) Pub. Date: May 28, 2020

(54) DEVICE AND METHOD FOR TRAINING NEURAL NETWORK

(71) Applicant: Electronics and Telecommunications Research Institute, Daejeon (KR)

(72) Inventors: Yong Hyuk MOON, Daejeon (KR); Jun Yong PARK, Daejeon (KR); Yong Ju LEE, Daejeon (KR)

(73) Assignee: Electronics and Telecommunications Research Institute, Daejeon (KR)

(21) Appl. No.: 16/696,061

(22) Filed: Nov. 26, 2019

(30) Foreign Application Priority Data
Nov. 27, 2018 (KR) 10-2018-0148859
Oct. 16, 2019 (KR) 10-2019-0128678

(51) Int. Cl. G06N 3/08; G06N 5/04; G06N 20/00; G06F 17/16

(52) U.S. Cl. CPC G06N 3/088; G06N 3/084; G06F 17/16; G06N 20/00; G06N 5/046

(57) ABSTRACT

Provided are a device and method for training a neural network. The method includes generating a candidate solution set by modifying a candidate solution which represents a basic neural network model in a variable-length string form, acquiring first candidate solutions by performing architecture variation-based unsupervised learning with a plurality of candidate solutions selected from the candidate solution set, selecting a neural network model represented by a first candidate solution which satisfies targeted effective performance as a first neural network model, acquiring second candidate solutions by performing selective error propagation-based supervised learning with the first neural network model, and selecting a neural network model represented by a second candidate solution which satisfies the targeted effective performance as a final neural network model.

### CLAIM FOR PRIORITY

This application claims priority to Korean Patent Application No. 10-2018-0148859 filed on Nov. 27, 2018 and No. 10-2019-0128678 filed on Oct. 16, 2019 in the Korean Intellectual Property Office (KIPO), the entire contents of which are hereby incorporated by reference.

### BACKGROUND

### 1. Technical Field

Example embodiments of the present invention relate in general to a device and method for training a neural network through unsupervised learning and supervised learning and more specifically to a device and method for effectively training a neural network with unclean data or very high dimensional data.

### 2. Related Art

A neural network-based deep learning methodology, which is accomplishing great results in the computer vision field, is rapidly spreading to various fields such as natural language processing, speech synthesis, knowledge transfer, multimodal learning, and automated machine learning (AutoML).

In particular, among deep learning methods, convolutional neural networks (CNNs), which are used for image classification, object recognition, and segmentation services, have reached a level similar to or higher than human intelligence. In addition, deep learning methods are evolving to new methods, such as reinforcement learning, a generative adversarial network (GAN), etc. which are representative artificial intelligence algorithms based on technical spirits totally different from existing deep learning methods.

The industrial paradigm is changing so that the productivity of a company is directly influenced by a new insight which is acquired by cleaning and analyzing raw data on the basis of the above-described technological advancement and rapidly applied to service. However, current deep learning methods are technically limited in terms of the amount of computation for learning and the size of a neural network model.

First, over-parameterization is problematic. Since manufacturing companies, Internet service providers, Internet of things (IoT) service providers, etc. manage systems which generate huge data in real time, it is necessary to devise a neural network structure which supports large-scale analysis and a related technique in order to efficiently analyze data. However, existing learning techniques have a problem in that it is necessary to train hyperparameters, which exponentially increase in number, in order to learn the representation of high-dimensional data whose feature correlation is difficult to interpret.

Second, data dependency is problematic. Neural network-based data analysis techniques, which are in the limelight these days, are recognized for the effect of inference only in specific data domains. Also, most data-dependent special neural networks are based on supervised learning, and thus learning is substantially impossible with data providing no label.

Lastly, computational overhead is problematic. A gradient descent-based error backpropagation technique is a universal weight-learning algorithm which is most widely used in learning of a deep neural network. However, the gradient descent-based error backpropagation technique requires the largest amount of computing resources for training and has a structure which makes learning model parallelism difficult. Also, the gradient descent-based error backpropagation technique is a human brain simulation technique in which it is not taken into consideration that the human brain's neural network is trained asymmetrically in practice, and thus does not accurately reflect the operating mechanism of the brain. In addition, in the case of error backpropagation, learning is not performed well as an error is further propagated toward an input layer.

To solve the above-described technical limitations of deep learning methods, model compression techniques, such as binarization, pruning, drop-out, and quantization. However, the model compression techniques are based on simple methods, such as simplification of weights and deletion of interneuron connections, without optimizing topology construction to acquire a desired level of representation in terms of target data. Consequently, the model compression techniques are not able to fundamentally overcome the technical limitations of deep learning methods.

### SUMMARY

Accordingly, example embodiments of the present invention are provided to substantially obviate one or more problems due to limitations and disadvantages of the related art.

Example embodiments of the present invention provide a method of training a neural network using architecture variation-based unsupervised learning and selective error propagation-based supervised learning, the method being able to effectively improving efficiency (efficiency in the amount of computation, learning time, model size, the number of hyperparameters, etc.) in neural network training and the accuracy of inference (a loss value and the like) without damaging major features of target data.

Example embodiments of the present invention also provide a method for solving major technical problems, such as a long learning time required by a large-scale neural network model due to over parameterization, the limited service application of a special neural network model subordinate to specific target data, the drawback of an error backpropagation-based weight update technique requiring the largest amount of computation for training, and the low structural degree of freedom of an existing neural network model compression technique which obstructs lightening of an artificial intelligence neural network model.

In some example embodiments, a method of training a neural network includes: generating a candidate solution set by modifying a candidate solution, which represents a basic neural network model in a variable-length string form; acquiring first candidate solutions by performing architecture variation-based unsupervised learning with a plurality of candidate solutions selected from the candidate solution set; selecting a neural network model represented by a first candidate solution which satisfies targeted effective performance as a first neural network model; acquiring second candidate solutions by performing selective error propagation-based supervised learning with the first neural network model; and selecting a neural network model represented by a second candidate solution which satisfies the targeted effective performance as a final neural network model.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of a device for training a neural network according to an example embodiment of the present invention;

FIG. 2 is a conceptual diagram illustrating a fine control neural network learning method according to an example embodiment of the present invention in terms of network structure and data training;

FIG. 3 is a flowchart of an architecture variation-based unsupervised neural network learning method employing unclean training data according to an example embodiment of the present invention;

FIG. 4 is a conceptual diagram illustrating a method of encoding a neural network model in a one-dimensional variable-length string form in an unsupervised neural network learning method according to an example embodiment of the present invention;

FIG. 5 is a conceptual diagram illustrating a first architecture variation-based learning method in an unsupervised neural network learning method according to an example embodiment of the present invention;

FIG. 6 is a conceptual diagram illustrating a second architecture variation-based learning method in an unsupervised neural network learning method according to an example embodiment of the present invention;

FIG. 7 is a conceptual diagram illustrating a new candidate solution set generated on the basis of candidate solutions having new features through second architecture variation;

FIG. 8 is a flowchart of a selective error propagation-based supervised neural network learning method employing clean training data according to an example embodiment of the present invention;

FIG. 9 is a conceptual diagram illustrating a selective error propagation-based supervised neural network learning method employing clean training data according to an example embodiment of the present invention;

FIG. 10 is a flowchart of a method of training a neural network according to an example embodiment of the present invention; and

FIG. 11 is a block diagram of a device for training a neural network according to another example embodiment of the present invention.

### DESCRIPTION OF EXAMPLE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in detail with reference to the accompanying drawings.

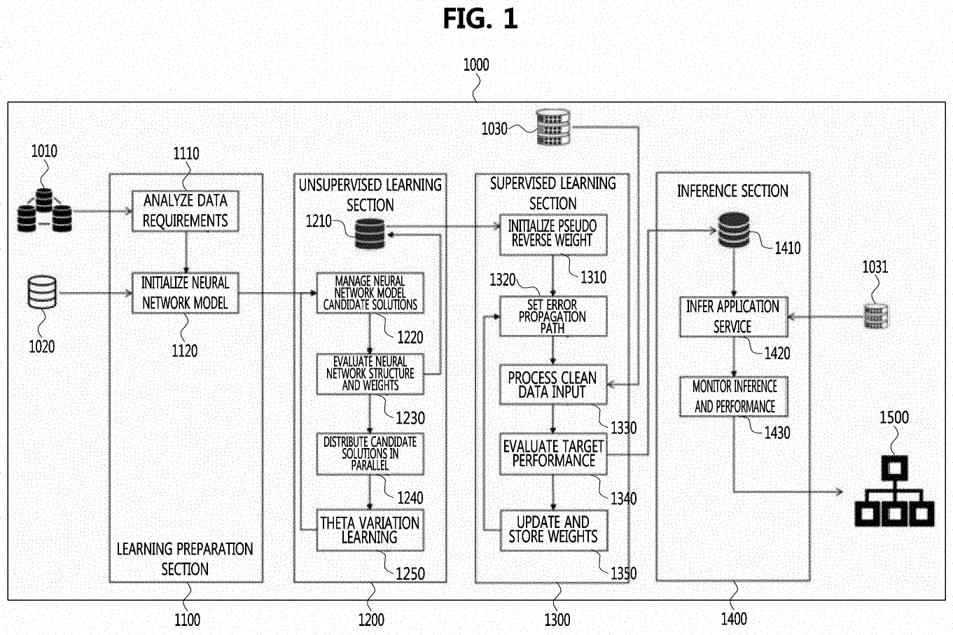

FIG. 1 is a conceptual diagram of a device for training a neural network according to an example embodiment of the present invention.

A device 1000 for training a neural network using architecture variation-based unsupervised learning and selective error propagation-based supervised learning according to an example embodiment of the present invention may include a learning preparation section 1100, an unsupervised learning section 1200, a supervised learning section 1300, and an inference section 1400. The individual sections constituting the device 1000 may be executed and managed in a single physical system or different systems.

Meanwhile, an unclean training data set 1010 may denote training data including no label or including labels of only some data. Consequently, the unclean training data set 1010 is not used in training based on supervised learning.

A basic neural network model storage 1020 may denote an entity for storing and managing a basic or common neural network model which may be used in data analysis required by a target application service.

A clean training data set 1030 may denote training data including labels. The clean training data set 1030 may include large-scale data which hardly provides labels or small-scale data most of which provides labels. Consequently, the clean training data set 1030 may be used in training based on supervised learning. Also, in the clean test data set 1031, clean test data to be used by the inference section 1400 may be stored and managed.

Meanwhile, the learning preparation section 1100 may include a data requirement analysis module 1110 and a neural network model initialization module 1120. The data requirement analysis module 1110 may analyze data types (e.g., image, text, voice, time-series data, etc.) acquired from the unclean training data set 1010, features, the purpose of inference required by the target application service, or the like.

The neural network model initialization module 1120 may perform a series of functions of interpreting the structure of a stored neural network model, constructing a neural network structure by decoding the interpretation results, and loading the decoded results in the form of process instances into a memory.

Meanwhile, the unsupervised learning section 1200 may include an unsupervised learning neural network model repository 1210, a neural network model candidate solution management module 1220, a neural network structure and weight evaluation module 1230, a candidate solution parallel distribution module 1240, and a theta variation learning module 1250.

The unsupervised learning neural network model repository 1210 may store and manage a neural network model which is finally acquired through architecture variation-based unsupervised learning and may be located outside the unsupervised learning section 1200.

The neural network model candidate solution management module 1220 may grasp a neural network structure and numerical features on the basis of the interpretation of a basic neural network model received from the neural network model initialization module 1120. Also, the neural network model candidate solution management module 1220 may generate a candidate solution by encoding the neural network model into a variable-length string in a one-dimensional vector form and generate a plurality of candidate solutions by arbitrarily modifying the candidate solution, thereby producing an initial candidate solution set.

The neural network structure and weight evaluation module 1230 may evaluate the performance of each individual candidate solution belonging to the candidate solution set and transfer the corresponding candidate solution to the unsupervised learning neural network model repository 1210 when the candidate solution satisfies targeted effective performance of the device 1000. In this case, the transferred candidate solution may be referred to as an optimal solution. Meanwhile, the neural network structure and weight evaluation module 1230 may include a function of feed-forwarding unclean training data to a neural network model constituted by the candidate solution in order to evaluate the performance of each individual candidate solution.

The candidate solution parallel distribution module 1240 may perform a function of distributing some of the candidate solution set or each individual candidate solution using a processing technique, such as multithreading, multicore, multi-graphics processing unit (GPU), or multi-machine.

The theta variation learning module 1250 may perform a function of encoding a basic neural network structure and weights into a candidate solution in a one-dimensional variable length string form and varying the candidate solution, and new candidate solutions which are acquired by the theta variation learning module 1250 varying the candidate solution may be transferred to the neural network model candidate solution management module 1220. The term “theta” collectively refers to a finally acquired neural network topology structure, weights, and biased values and may determine how well a combination of the aforementioned values represents given unclean training data.

Meanwhile, the supervised learning section 1300 may include a pseudo reverse weight initialization module 1310, an error propagation path setting module 1320, a clean data input processing module 1330, a target performance evaluation module 1340, and a weight update and storage module 1350.

The pseudo reverse weight initialization module 1310 may interpret a neural network model acquired from the unsupervised learning neural network model repository 1210 and generate or initialize a pseudo reverse weight which will be used for a weight update.

The error propagation path setting module 1320 may calculate the density value of each individual weight matrix from the neural network model acquired from the unsupervised learning neural network model repository 1210 and differentiate the importance of weight matrices according to density values. Consequently, it is possible to identify a layer in which a weight matrix having relatively high importance is located, and in error propagation for a weight update, the layer may be set as a branch point.

The clean data input processing module 1330 may acquire data from the clean training data set 1030 and perform processing such as changing a data form and structure to a suitable form for the neural network model. Also, the clean data input processing module 1330 may perform a function of feed-forwarding input data to the neural network model.

The target performance evaluation module 1340 may calculate an error which has occurred in the output layer of the neural network model, that is, the difference between an estimation value and a label, and determine whether the target performance of the device 1000 is satisfied. Consequently, when it is determined that the target performance of the device 1000 is satisfied, the target performance evaluation module 1340 may transfer the neural network model which has finished learning to a supervised learning neural network model repository 1410 of the inference section 1400.

The weight update and storage module 1350 may back-propagate the error which has occurred in the output layer of the neural network model from the output layer toward the input layer on the basis of the set pseudo reverse weight matrix and a branch layer for error propagation and may calculate a contribution (an error difference value) of the weight matrix of each layer toward the error. Subsequently, the weight update and storage module 1350 may calculate update values of the weight matrix of each layer using layer-specific error difference values, thereby generating a newly updated weight matrix.

Meanwhile, the inference section 1400 may include the supervised learning neural network model repository 1410, an application service inference module 1420, and an inference and performance monitoring module 1430.

The supervised learning neural network model repository 1410 may store and manage the neural network model which has finished learning by the supervised learning section 1300.

The application service inference module 1420 may make an inference suitable for the requirements of an application service using the neural network model acquired from the supervised learning neural network model repository 1410 and the data acquired from the clean test data set 1031. For example, the inference suitable for the requirements of the application server may be data classification, identification, conversion, estimation, and the like. The inference and performance monitoring module 1430 may perform a function of checking inference results in real time and transferring the results to a third entity 1500 or accumulating the results.

Meanwhile, the third entity 1500 may denote an external entity which uses the inference results acquired from the inference section 1400 and a performance indicator. For example, the third entity may be an external system, the target application service, a service manager, a service user, or the like.

The sections and modules are an example which may be taken into consideration among several system configurations, and other functional devices which may be taken into consideration by relevant general researchers or developers may be added through merging or interoperation according to the type of target data, a service management policy, a current configuration of computing resources, and the like.

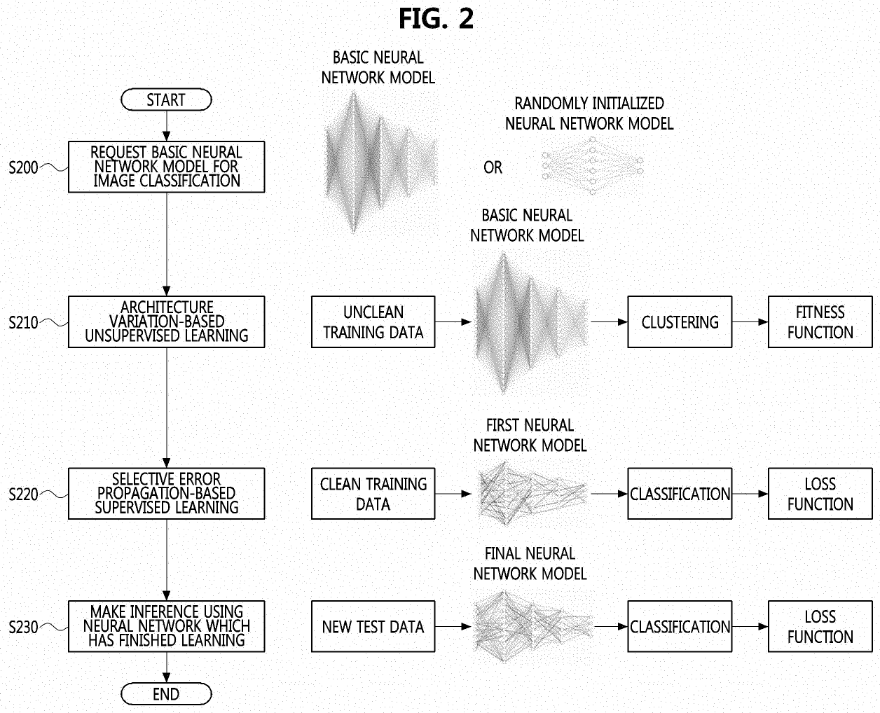

FIG. 2 is a conceptual diagram illustrating a fine control neural network learning method according to an example embodiment of the present invention in terms of network structure and data training.

Referring to FIG. 2, a method of training a neural network according to an example embodiment of the present invention may include an operation S200 of generating a basic neural network model for image classification. Meanwhile, the basic neural network model for image classification may denote an existing neural network model which is used to perform an inference function on the basis of the data of a domain required by a target application service or a neural network model which is useful to perform similar inference. Neural network models may have various neural network structures, such as a fully-connected neural network, a directed acyclic graph, a star graph, a random graph, a convolution neural network, and a recurrent neural network. Meanwhile, when no basic neural network model is given, it is possible to use a randomly initialized neural network model in which a total number of neurons constituting the neural network is small, the depth is shallow, and there are small number of weight connections.

Subsequently, the method of training a neural network according to an example embodiment of the present invention may include an architecture variation-based unsupervised learning operation S210. More specifically, it is possible to cluster data having similar features by inputting unclean training data to the untrained basic neural network model. Also, correlations between pieces of unclean training data are not analyzed simply through weight modification, but it is possible to learn major features of data through neural network structure variation. Such unsupervised learning may accelerate supervised learning. In addition, a fitness function may calculate a targeted effective performance value.

The method of training a neural network according to an example embodiment of the present invention may include a selective error propagation-based supervised learning operation S220. The selective error propagation-based supervised learning operation may include an operation of performing training to improve accuracy in image classification on the basis of clean training data and the neural network model which has finished architecture variation-based unsupervised learning. Meanwhile, a loss function may denote an error evaluation function for calculating a targeted effective performance value.

The method of training a neural network according to an example embodiment of the present invention may include an operation S230 of making an inference by using a neural network whose training has been finished. The operation of making an inference may include an operation of inferring the purpose of image classification on the basis of new test data and the neural network model which has finished selective error propagation-based supervised deep learning.

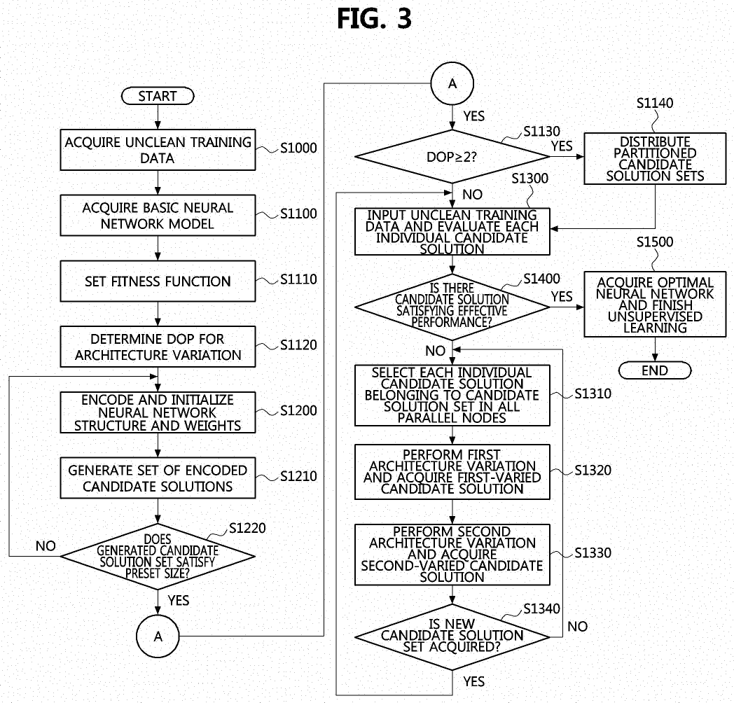

FIG. 3 is a flowchart of an architecture variation-based unsupervised neural network learning method employing unclean training data according to an example embodiment of the present invention.

FIG. 3 is a flowchart illustrating in detail an architecture variation-based unsupervised neural network learning method employing unclean training data performed by the unsupervised learning section 1200 of FIG. 1 in the architecture variation-based unsupervised learning operation S210 of FIG. 2.

The neural network learning method according to an example embodiment of the present invention may include an operation S1000 of acquiring unclean training data and an operation S1100 of acquiring a basic neural network model suitable for an inference purpose from a target application service. However, when there is no suitable basic neural network model, any neural network model having a simple structure may be generated and used.

The method may also include an operation S1110 of selecting a fitness function. For example, a fitness function may be selected on the basis of how well a varied neural network model represents given data. A loss function which is mainly used in supervised learning may also be used as a fitness function. The number of repetitions of training may also be used as the indicator of continuous or stopped learning. A fitness function may also be generated by combining several indicators. As a result, the orientation of architecture variation may be set according to how a fitness function is defined. In other words, a fitness function may be constraints on a structural change and weight update of a neural network model.

The method may also include an operation S1120 of determining the degree of parallelism (DOP) in architecture variation-based unsupervised neural network learning. When parallelism is allowed in architecture variation-based unsupervised neural network learning, it is possible to accelerate unsupervised learning. For example, parallel processing may be performed by multiple cores, a GPU, or a plurality of computing resources. The plurality of computing resources may be referred to as nodes or parallel nodes.

The method may include an operation S1130 of determining the DOP in detail to accelerate unsupervised learning. Meanwhile, when the DOP is set to 2 or more, it is possible to perform an operation S1140 of distributing partitioned candidate solution sets. When the DOP is set to less than 2, it is possible to perform an operation S1300 of evaluating an unclean training data input and each individual candidate solution.

The method may also include an operation S1200 of analyzing the basic neural network model, initializing a weight with any value when the weight required for training the basic neural network is not given, and generating a candidate solution in a variable-length string form by using the neural network structure and the initialized weight.

The method may also include an operation S1210 of generating a plurality of candidate solutions using the initial candidate solution, which has been acquired using the neural network structure and the initialized weight. The additional candidate solutions may be generated by adding or removing any connection structure of the initial candidate solution, changing a weight value, or the like. In other words, through the operation of generating a plurality of candidate solutions, it is possible to acquire a plurality of neural network models formed in structures or with weight values which are slightly different from the structure or the weight values of the basic neural network. All the generated candidate solutions may be collectively referred to as a candidate solution set.

The method may also include an operation S1220 of determining whether the size of the generated candidate solution set (the number of candidate solutions) reaches a preset number. When the size of the generated candidate solution set reaches the preset number, the next operation may be performed. On the other hand, when the size of the generated candidate solution set does not reach the preset number, the operation S1200 of generating a candidate solution by adding or removing any connection structure and initializing a weight value with any value may be repeatedly performed. Subsequently, the method may include an operation S1140 of, when the DOP is set to 2 or more and thus it is necessary to perform unsupervised learning in at least two parallel nodes, dividing the whole candidate solution set by the number of parallel nodes which will use the candidate solution set and distribute the partitioned candidate solution sets. In this case, a candidate solution set distributed to each parallel node may be referred to as a candidate solution subset.

The method may also include the operation 1300 of, when the DOP is set to less than 2, calculating results and a performance indicator by feed-forwarding unclean training data to one neural network model constituted by each individual candidate solution belonging to all or some of the candidate solution sets because each individual candidate solution includes the interneuron connection structure and weight information of a neural network. The result and the relevant performance indicator may be quantitatively calculated according to the fitness function. Meanwhile, the unclean training data may be partitioned into specific batch units and then input.

The method may also include an operation S1400 of calculating the fitness function and an effective performance indicator and determining whether there is at least one candidate solution satisfying effective performance in the candidate solution set. When there is at least one candidate solution satisfying the effective performance, the candidate solution may be designated as an optimal neural network S1500, and initial learning may be finished. Meanwhile, one or more candidate solutions satisfying the effective performance may be acquired, and an optimal candidate solution and relevant results may be stored and managed. When there is no candidate solution satisfying the effective performance, it is possible to perform an operation S1310 of selecting each individual candidate solution from the whole candidate solution set stored in all the parallel nodes.

Specifically, the operation S1310 of selecting each individual candidate solution from the whole candidate solution set stored in all the parallel nodes may include an operation of probabilistically selecting two candidate solutions from the whole candidate solution set which is distributed over a plurality of parallel nodes (in the case of DOP being set to 2 or more) or stored in a single parallel node (in the case of DOP being set to 1). According to a probabilistic selection method, a candidate solution having a higher effective performance indicator may be set to have a high probability of selection. Two candidate solutions may be finally selected by using a method of selecting specific number of random candidate solutions from the candidate solution set and then selecting a candidate solution having the highest effective performance indicator from among the selected candidate solutions. Each of the selected two candidate solutions may be encoded into a variable-length string in a one-dimensional vector form. Meanwhile, parallel nodes may denote computing resources which performs parallel processing.

The method may also include an operation S1320 of acquiring one first-varied candidate solution by merging (first architecture variation) the two candidate solutions selected in the operation S1310 of selecting each individual candidate solution from the whole candidate solution set stored in all the parallel nodes. Meanwhile, merging may be a function of generating a new neural network model having a different feature from the two candidate solutions. The feature may denote the topology and representation of the neural network model. In particular, in searching for a neural network structure and weight values which may best represent features of the given unclean training data, first architecture variation may allow global search in an entire search space by increasing the diversity of candidate solutions.

The method may also include an operation S1330 of acquiring a second-varied candidate solution by deriving a second architecture variation from the first-varied new candidate solution. Features of the first-varied new candidate solution may be changed by the second architecture variation. Meanwhile, the second architecture variation process may be classified as weight modification, interneuron connection removal, interneuron connection addition, neuron removal, and neuron addition and may be performed separately or in combination by a probabilistic selection.

Specifically, weight modification may denote to adjust the representation learning strength of the given unclean training data according to layers or neurons by changing a specific number of any weight values of the new candidate solution because there is necessarily a weight matrix for quantitatively acquiring the representation of given data between individual layers constituting a neural network.

Interneuron connection removal may be removal of the connection between two neurons present in different layers, denoting that there is no correlation between the two neurons in learning the representation of unclean training data and that it is possible to lighten the amount of computation and memory required for learning by removing parameters which are unnecessary for learning.

Interneuron connection addition may denote a second architecture variation method of expanding the representation of unclean training data to a learning structure unlike interneuron connection removal. For example, when a new connection is additionally made from a neuron in a first layer to a neuron in a third layer, a new neuron may be added in a second layer to relay the connection between the two neurons. Also, any weight values whereby connection strengths between the three neurons are determined may be initialized and given.

Neuron removal may denote to perform a function of reducing the neural network model by removing a specific number of neurons from the new candidate solution in the second architecture variation method. When a neuron is removed, all connections related to the neuron may be lost. Also, when a third neuron loses all connections due to the removal of a specific neuron, the corresponding neuron may be additionally removed.

Neuron addition may denote to add a specific number of neurons to any layer in the new candidate solution in the second architecture variation method. Also, a new neuron may be added to have a connection which has been initialized with any weight, or a new neuron having no connection may be added.

The method may also include an operation S1340 of checking whether new candidate solutions corresponding to a preset candidate solution set size are acquired by performing first architecture variation and second architecture variation. When a new candidate solution set having the preset candidate solution set size is acquired, it is possible to perform the operation 51300 of inputting unclean training data to the neural network model and calculating results and a performance indicator. On the other hand, when the number of new candidate solutions is smaller than the preset candidate solution set size, it is possible to repeatedly perform the operations S1310, S1320, S1330, and S1340 of selecting and extracting two arbitrary candidate solution and additionally acquiring new candidate solutions through first architecture variation and second architecture variation.

The above-described method may be performed in parallel by a logically single thread, a process, a physically independent central processing unit (CPU) core, a GPU core, or a separate computing device.

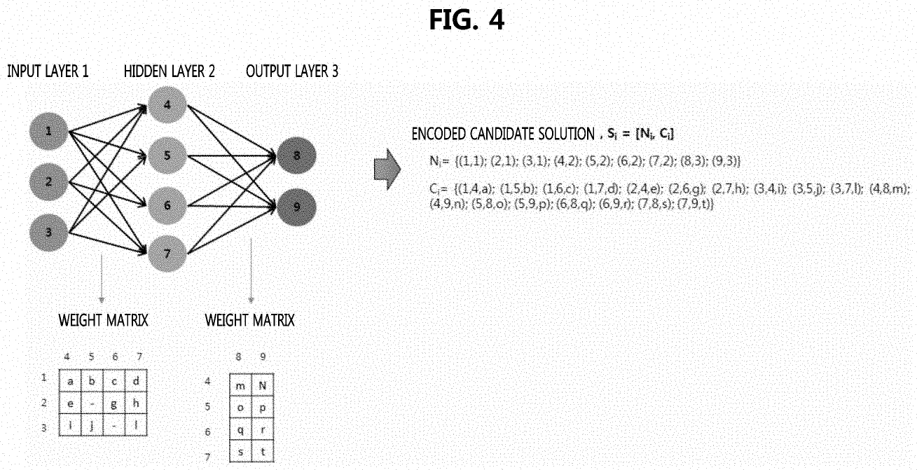

FIG. 4 is a conceptual diagram illustrating a method of encoding a neural network model in a one-dimensional variable-length string form in an unsupervised neural network learning method according to an example embodiment of the present invention.

Referring to FIG. 4, a basic neural network model may include an input layer 1 composed of three neurons (first to third neurons), a hidden layer 2 composed of four neurons (fourth to seventh neurons), and an output layer 3 composed of two neurons (eighth and ninth neurons).

A weight matrix may exist between the input layer 1 and the hidden layer 2 and also between the hidden layer 2 and the output layer 3. For example, a weight value connecting the first neuron and the fourth neuron may be “a,” and a weight value connecting the second neuron and the sixth neuron may be “g.” In the weight matrices, an element value of a hyphen “-” may denote that there is no connection between the two neurons. Also, lowercase letters “a” to “t” may denote any floating-point values.

The basic neural network model may include three elements, a neural network structure, neural interconnections, and weight matrices, and a candidate solution encoding schema reflects all of the three elements. Consequently, as shown in Expression 1, an i^{th} candidate solution Si of an encoded candidate solution may be represented by Nᵢ, which represents the neural network structure as a string, and Cᵢ, which represents the neural interconnections and weight matrices as a string.

Sᵢ=[Nᵢ, Cᵢ] [Expression 1]

The basic neural network structure may be represented as a variable-length string Nᵢ in a one-dimensional vector form. For example, the first “1” in (1, 1) may denote the first neuron, and the second “1” may denote the input layer. Also, “5” in (5, 2) may denote the fifth neuron, and “2” may denote the hidden layer. That is, (5, 2) may denote that the fifth neuron exists in the hidden layer. In other words, a neuron belonging to a specific layer may be defined to be a 2-tuple in a (neuron index number, layer index number) format as shown in Expression 2, and each tuple may use a semicolon as a delimiter.

Nᵢ={(1, 1); (2, 1); (3, 1); (4, 2); (5, 2); (6, 2); (7, 2); (8, 3); (9, 3)} [Expression]

The interconnection and weight matrices of the basic neural network may be represented as a variable-length string Cᵢ in a one-dimensional vector form. For example, (1, 4, a) may denote that there is a connection between the first neuron and the fourth neuron and a weight value representing the strength of the connection is “a.” Also, (6, 8, q) may denote that there is a connection between the sixth neuron and the eighth neuron and a weight value representing the strength of the connection is “q.” In other words, the connection between any two neurons and the connection strength may be defined as a 3-tuple in a (neuron, neuron, weight value) format as shown in Expression 3, and tuples may be delimited by semicolons.

Cᵢ={(1, 4, a); (1, 5, b); (1, 6, c); (1, 7, d); (2, 4, e); (2, 5, f); (2, 6, g); (2, 7, h); (3, 4, i); (3, 5, j); (3, 6, k); (3, 7, 1); (4, 8, m); (4, 9, n); (5, 8, o); (5, 9, p); (6, 8, q); (6, 9, r); (7, 8, s); (7, 9, t)} [Expression 3]

Although only weights are taken into consideration in the above-described candidate solution encoding method, the encoding method may be easily expanded to an encoding method in which bias values are taken into consideration.

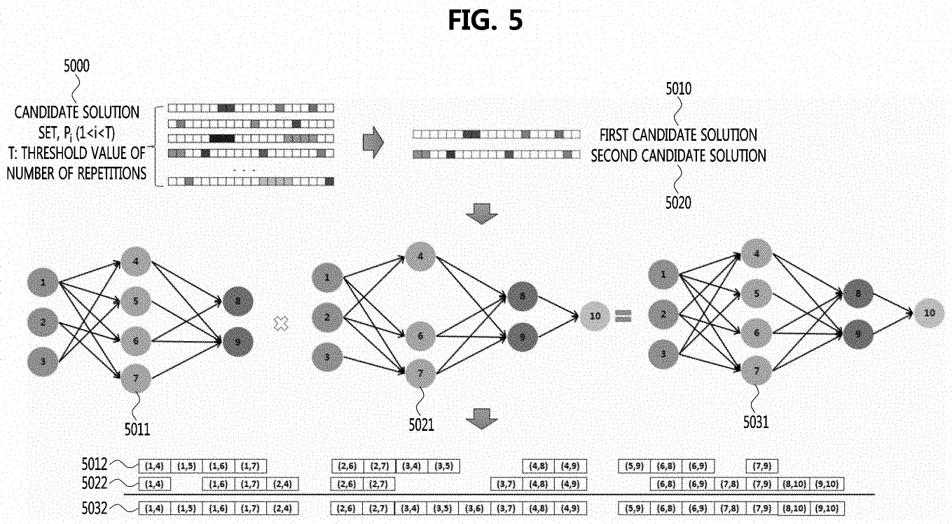

FIG. 5 is a conceptual diagram illustrating a first architecture variation-based learning method in an unsupervised neural network learning method according to an example embodiment of the present invention.

Referring to FIG. 5, “i” in the i^{th} candidate solution set (Pᵢ, 5000) may denote the generation index of a candidate solution set acquired by repeating the operation S1300 of inputting unclean training data and evaluating each individual candidate solution to the operation S1340 of acquiring a new candidate solution set in FIG. 3. Meanwhile, the value of “i” may be assumed to be a value which is larger than 1 and smaller than any set threshold value T. X shown in FIG. 5 and Expression 4 may be a merging sign representing first architecture variation. A first candidate solution 5010 may denote a first candidate solution selected through the operation S1310 of selecting each individual candidate solution belonging to the whole candidate solution set from all the parallel nodes. The first candidate solution 5010 may be represented as Sⁱₓ, an x^{th} candidate solution belonging to an i^{th} candidate solution set.

Also, a second candidate solution 5020 may denote a second candidate solution selected through the operation S1310 of selecting each individual candidate solution belonging to the whole candidate solution set from all the parallel nodes. The second candidate solution 5020 may be represented as Sⁱ_{y}, an y^{th} candidate solution belonging to the i^{th} candidate solution set.

FIG. 5 shows a new candidate solution 5031 generated through first architecture variation (merging) of the first candidate solution 5010, which is depicted as a neural network model 5011, and the second candidate solution 5020, which is depicted as a neural network model 5021. In other words, the new candidate solution 5031 may be derived by merging the first candidate solution 5010 and the second candidate solution 5020 as shown in Expression 4. In this case, the new candidate solution 5031 may be assumed to be a k^{th} candidate solution constituting an (i+1)^{th} candidate solution set.

Sⁱₓ×Sⁱ_{y}→Sⁱ⁺¹ₖ [Expression 4]

The first candidate solution 5010 and the second candidate solution 5020 ay be represented in a one-dimensional variable-length string form according to a candidate solution encoding schema as shown in Expressions 5 and 6.

Sⁱₓ=[Nⁱₓ, Cⁱₓ]

Nⁱₓ={(1, 1); (2, 1); (3, 1); (4, 2); (5, 2); (6, 2); (7, 2); (8, 3); (9, 3)}

Cⁱₓ={(1, 4, 0.8); (1, 5, −0.02); (1, 6, 3.2); (1, 7, 0.2); (2, 6, 3.4); (2, 7, 1.02); (3, 4, 6.2); (3, 5, 1.5); (4, 8, −1.02); (4, 9, 0.5); (5, 9, 3.12); (6, 8, 0.2); (6, 9, 0.56); (7, 9, 0.2)} [Expression 5]

Sⁱ_{y}=[Nⁱ_{y}, Cⁱ_{y}]

Nⁱ_{y}={(1, 1); (2, 1); (3, 1); (4, 2); (6, 2); (7, 2); (8, 3); (9, 3); (10, 4)}

Cⁱ_{y}={(1, 4, 0.5); (1, 7, 0.34); (2, 4, 2.2); (2, 6, 0.2); (2, 7, 1.2); (3, 7, 3.2); (4, 8, 0.05); (4, 9, 1.25); (6, 8, 3.12); (6, 9, 0.08); (7, 8, 2.1); (7, 9, 0.23); (8, 10, 0.65); (9, 10, 0.45)} [Expression 6]

FIG. 5 also shows a new candidate solution 5032 derived by merging a first candidate solution 5012 and the second candidate solution 5022, which are represented in a string form and encoded in consideration of neural interconnections of a neural network model. Meanwhile, FIG. 5 schematically shows a first architecture variation process based on merging of the first candidate solution 5012, the second candidate solution 5022, and the new candidate solution 5032 unlike Expressions 5 and 6. Merging of the first candidate solution 5012 and the second candidate solution 5022 is described in detail as follows. When the two candidate solutions have the same neural connection, for example, (1, 4) may denote that the first neuron and the fourth neuron are connected, and it is possible to see that the connection (1, 4) exists in the two candidate solutions. In this case, any one of the two candidate solutions may be selected to constitute a first element of the new candidate solution 5032. In the same manner, the neural connections (1, 6), (1, 7), (2, 6), (2, 7), (4, 8), (4, 9), (6, 8), (6, 9), and (7, 9) may be applied to the new candidate solution 5032.

Also, when a neural connection exists only in one candidate solution, for example, (1, 5) exists only in the first candidate solution 5012 and thus may be applied to the new candidate solution 5032 as a second element. In the same manner, (2, 4), (3, 4), (3, 5), (3, 7), (5, 9), (7, 8), (8, 10), and (9, 10) may be simply merged and constitute the new candidate solution 5032.

In addition, when there is no neural connection, for example, the neural connection (5, 8) is not provided by either of the two candidate solutions, and thus it is possible to consider that there is nothing to be applied to the new candidate solution 5032.

It is possible to acquire a final first-varied new candidate solution through the above-described candidate solution merging, and the new candidate solution may be represented by Expression 7. Consequently, a candidate solution Sⁱ⁺¹ₖ which has a varied structure and varied weights, that is, new features, may be acquired through the first architecture variation.

Sⁱ⁺¹ₖ=[Nⁱ⁺¹ₖ, Cⁱ⁺¹ₖ]

N^{i|1}ₖ={(1, 1); (2, 1); (3, 1); (4, 2); (6, 2); (7, 2); (8, 3); (9, 3); (10, 4)}

Cⁱ⁺¹ₖ={(1, 4, 0.5); (1, 5, −0.02); (1, 6, 3.2); (1, 7, 0.2); (2, 4, 2.2); (2, 6, 0.2); (2, 7, 1.2); (3, 4, 6.2); (3, 5, 1.5); (3, 7, 3.2); (4, 8, 0.05); (4, 9, 0.5); (5, 9, 3.12); (6, 8, 0.2); (6, 9, 0.56); (7, 8, 2.1); (7, 9, 0.23); (8, 10, 0.65); (9, 10, 0.45)} [Expression 7]

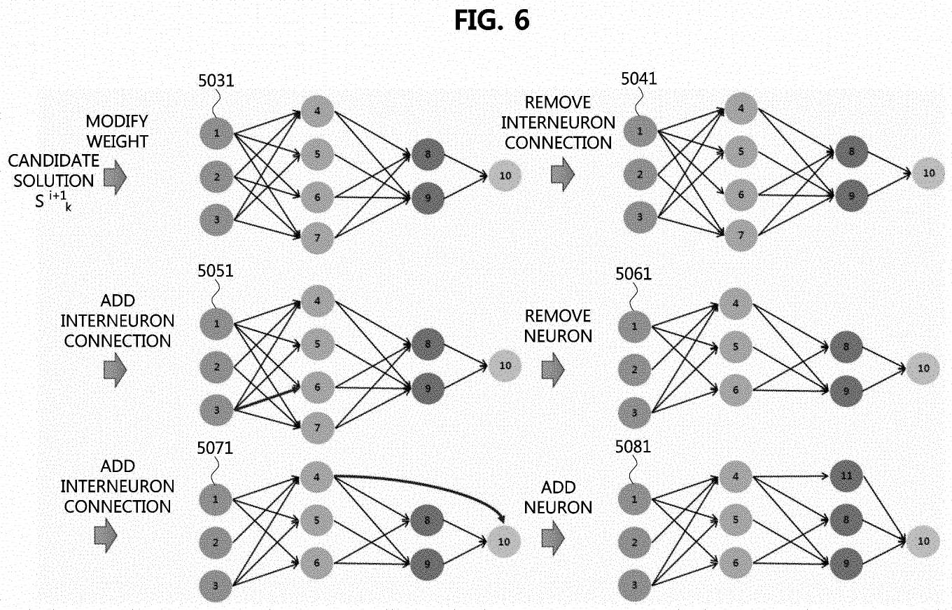

FIG. 6 is a conceptual diagram illustrating a second architecture variation-based learning method in an unsupervised neural network learning method according to an example embodiment of the present invention.

Referring to FIG. 6, second architecture variation may be classified as weight modification, interneuron connection removal, interneuron connection addition, neuron removal, and neuron addition and may be performed separately or in combination in the case of changing features of a candidate solution. Also, second architecture variation may be made to reflect both of numerical feature changes and a structural feature change of a neural network model.

Also, a candidate solution Sⁱ⁺¹ₖ₁ calculated by performing weight modification, which is a kind of second architecture variation, in the new candidate solution Sⁱ⁺¹ₖ acquired through first architecture variation may be depicted in a neural network form (5031). First, in weight modification, a plurality of neural connections may be selected according to a predefined probability value, and weight values may be changed. In addition, a random sampling method may be used to change any weight values.

Meanwhile, Expression 8 represents a case in which any weight values in the new candidate solution S^{i|1}ₖ acquired through first architecture variation are changed by using a 4-point weight variation method. In Expression 8, M_{wm} may denote a weight modification (WM) function. Comparing Expression 7 with Expression 8, it is possible to see that a weight matrix is changed from (2, 7, 1.2) to (2, 7, 1.35), that is, a weight is modified. Also, it is possible to see that the weight value of each neural connection is changed from (5, 9, 3.12) to (5, 9, 2.97), from (7, 8, 2.1) to (7, 8, 2.01), and from (8, 10, 0.65) to (8, 10, 0.942). To distinguish between the candidate solution before weight modification and the candidate solution after weight modification, subscripts k and k1 may be used, respectively. Meanwhile, to limit the degree of freedom of weight modification, a minimum or maximum change from an existing weight value may be set. Also, Nⁱ⁺¹ₖ which represents the neural structure of an existing new candidate solution is not affected by weight modification and thus is maintained as it is. However, Nⁱ⁺¹ₖ represents the neural structure after weight modification and thus may be referred to as Nⁱ⁺¹ₖ₁ as shown in Expression 9. As a result, it is possible to acquire the varied candidate solution Sⁱ⁺¹ₖ₁ by applying weight modification to the new candidate solution as shown in Expression 10.

M_{wm}(Cⁱ⁺¹ₖ₁={(1, 4, 0.5); (1, 5, −0.02); (1, 6, 2.77); (1, 7, 0.2); (2, 4, 2.2); (2, 6, 0.2); (2, 7, 1.35); (3, 4, 6.2); (3, 5, 1.5); (3, 7, 3.2); (4, 8, 0.05); (4, 9, 0.5); (5, 9, 2.97); (6, 8, 0.2); (6, 9, 0.56); (7, 8, 2.01); (7, 9, 0.23); (8, 10, 0.942); (9, 10, 0.45)} [Expression 8]

M_{wm}(Nⁱ⁺¹ₖ)→Nⁱ⁺¹ₖ₁ [Expression 9]

Sⁱ⁺¹ₖ=[Nⁱ⁺¹ₖ, Cⁱ⁺¹ₖ]→Sⁱ⁺¹ₖ₁=[Nⁱ⁺¹ₖ₁, Cⁱ⁺¹ₖ₁] [Expression 9]

Also, a candidate solution Sⁱ⁺¹ₖ₂ acquired by performing interneuron connection removal, which is a kind of second architecture variation, in the varied candidate solution Sⁱ⁺¹ₖ₁ may be depicted in a neural network form (5041). In other words, a one-dimensional vector Cⁱ⁺¹ₖ₂ representing anew neural connection structure as shown in Expression 11 may be derived by removing the connection between the second neuron in the input layer and the sixth neuron in the first hidden layer from the candidate solution Sⁱ⁺¹ₖ₁. To distinguish between the candidate solution before the interneuron connection removal and the candidate solution after the interneuron connection removal, subscripts k1 and k2 may be used, respectively. Comparing Expression 11 with Expression 8, it is possible to see that the weight matrix (2, 6, 0.2) has been deleted and thus the neural connection has been deleted. Meanwhile, M_{cr} may denote a connection removal (CR) function. Since the second neuron maintains its connection structure such as (2, 4, 2.2) and (2, 7, 1.35) and the sixth neuron maintains its connection structure such as (1, 6, 2.77), (6, 8, 0.2), and (6, 9, 0.56), it is possible to see that neuron connections of the second and sixth neurons are not deleted by the interneuron connection removal. Also, Nⁱ⁺¹ₖ₁ which represents the neural structure of the candidate solution Sⁱ⁺¹ₖ₁ is not affected by the neural connection removal and thus is maintained as it is. However, Nⁱ⁺¹ₖ₁ represents the neural structure after the neural connection removal and thus may be referred to as Nⁱ⁺¹ₖ₂ as shown in Expression 12. As a result, it is possible to acquire the varied candidate solution Sⁱ⁺¹ₖ₂ by applying the interneuron connection removal to the candidate solution Sⁱ⁺¹ₖ₁ as shown in Expression 13.

M_{cr}(Cⁱ⁺¹ₖ₁)=Cⁱ⁺¹ₖ₂={(1, 4, 0.5); (1, 5, −0.02); (1, 6, 2.77); (1, 7, 0.2); (2, 4, 2.2); (2, 7, 1.35); (3, 4, 6.2); (3, 5, 1.5); (3, 7, 3.2); (4, 8, 0.05); (4, 9, 0.5); (5, 9, 2.97); (6, 8, 0.2); (6, 9, 0.56); (7, 8, 2.01); (7, 9, 0.23); (8, 10, 0.942); (9, 10, 0.45)} [Expression 11]

M_{cr}(Nⁱ⁺¹ₖ₁)→N ⁱ⁺¹ₖ₂ [Expression 12]

S^{i|1}ₖ₁=[N^{i|1}ₖ₁, C^{i|1}ₖ₁]→S^{i|1}ₖ₂=[N^{i|1}ₖ₂, C^{i|1}ₖ₂] [Expression 13]

Also, a candidate solution Sⁱ⁺¹ₖ₃ acquired by performing interneuron connection addition, which is a kind of second architecture variation, in the candidate solution Sⁱ⁺¹ₖ₂ may be depicted in a neural network form (5051). In other words, when the connection between the third neuron in the input layer and the sixth neuron in the first hidden layer is added to the candidate solution Sⁱ⁺¹ₖ₂, a one-dimensional vector Cⁱ⁺¹ₖ₃ representing a new neural connection structure as shown in Expression 14 may be derived. To distinguish between the candidate solution before the interneuron connection addition and the candidate solution after the interneuron connection addition, subscripts k2 and k3 may be used, respectively. Comparing Expression 14 with Expression 11, it is possible to see that the weight matrix (3, 6, 0.892) has been added and thus the neural connection has been added. Meanwhile, M_{ca} may denote a connection addition (CA) function. Also, Nⁱ⁺¹ₖ₂ which represents the neural structure of the candidate solution Sⁱ⁺¹ₖ₂ is not affected by the neural connection addition and thus is maintained as it is. However, Nⁱ⁺¹ₖ₂ represents the neural structure after the neural connection addition and thus may be referred to as Nⁱ⁺¹ₖ₃ as shown in Expression 15. As a result, it is possible to acquire the varied candidate solution Sⁱ⁺¹ₖ₃ by applying the interneuron connection addition to the candidate solution Sⁱ⁺¹ₖ₂ as shown in Expression 16.

M_{ca}(Cⁱ⁺¹ₖ₂)=Cⁱ⁺¹ₖ₃={(1, 4, 0.5); (1, 5, −0.02); (1, 6, 2.77); (1, 7, 0.2); (2, 4, 2.2); (2, 7, 1.35); (3, 4, 6.2); (3, 5, 1.5); (3, 6, 0.892); (3, 7, 3.2); (4, 8, 0.05); (4, 9, 0.5); (5, 9, 2.97); (6, 8, 0.2); (6, 9, 0.56); (7, 8, 2.01); (7, 9, 0.23); (8, 10, 0.942); (9, 10, 0.45)} [Expression 14]

M_{ca}(Nⁱ⁺¹ₖ₂)→Nⁱ⁺¹ₖ₃ [15]

Sⁱ⁺¹ₖ₂=[Nⁱ⁺¹ₖ₂, Cⁱ⁺¹ₖ₂]→Sⁱ⁺¹ₖ₃=[Nⁱ⁺¹ₖ₃, Cⁱ⁺¹ₖ₃] [16]

Also, a candidate solution S^{i|1}ₖ₄ acquired by performing neuron removal, which is a kind of second architecture variation, in the candidate solution Sⁱ⁺¹ₖ₃ may be depicted in a neural network form (5061). In other words, when the seventh neuron in the first hidden layer is removed from the candidate solution Sⁱ⁺¹ₖ₃, weight matrices (1, 7, 0.2), (2, 7, 1.35), (3, 7, 3.2), (7, 8, 2.01), and (7, 9, 0.23) are deleted from Expression 17 in comparison Expression 14, and thus a new one-dimensional vector Cⁱ⁺¹ₖ₄ in which neural interconnections have been lost may be derived. To distinguish between the candidate solution before the neuron removal and the candidate solution after the neuron removal, subscripts k3 and k4 may be used, respectively. Mₙᵣ may denote neuron removal (NR) function. Comparing Expression 18 with Expression 7, since the seventh neuron is removed, a neural network model Nⁱ⁺¹ₖ₄ of the candidate solution Sⁱ⁺¹ₖ₄ may be produced by deleting the tuple (7, 2) in the neural network model Nⁱ⁺¹ₖ₃ of the candidate solution Sⁱ⁺¹ₖ₃. As a result, it is possible to acquire the varied candidate solution Sⁱ⁺¹ₖ₄ by applying neuron removal to the candidate solution Sⁱ⁺¹ₖ₃ as shown in Expression 19.

Mₙᵣ₍Cⁱ⁺¹ₖ₃)=Cⁱ⁺¹ₖ₄={(1, 4, 0.5); (1, 5, −0.02); (1, 6, 2.77); (2, 4, 2.2); (3, 4, 6.2); (3, 5, 1.5); (3, 6, 0.892); (4, 8, 0.05); (4, 9, 0.5); (5, 9, 2.97); (6, 8, 0.2); (6, 9, 0.56); (8, 10, 0.942); (9, 10, 0.45)} [Expression 17]

Mₙᵣ(Nⁱ⁺¹ₖ₃)=Nⁱ⁺¹ₖ₄={(1, 1); (2, 1); (3, 1); (4, 2); (5, 2); (6, 2); (8, 3); (9, 3); (10, 4)} [Expression 18]

Sⁱ⁺¹ₖ₃=[Nⁱ⁺¹ₖ₃, Cⁱ⁺¹ₖ₃]→Sⁱ⁺¹ₖ₄=[Nⁱ⁺¹ₖ₄, Cⁱ⁺¹ₖ₄] 19]

Also, addition of the connection between neurons which exist in inconsecutive layers unlike in the above-described interneuron connection addition may be depicted (5071 and 5081). In particular, when interneuron connection addition, which is a kind of second architecture variation, is performed in the candidate solution Sⁱ⁺¹ₖ₄, a new interconnection in the neural network model may be depicted (5071).

Further, when a new neural connection is added between the fourth neuron 4 of the first hidden layer and the tenth neuron of the output layer in the candidate solution Sⁱ⁺¹ₖ₄, an eleventh neuron newly added the second hidden layer may be depicted (5081). Therefore, a neural network model structure Nⁱ⁺¹ₖ₅ of a candidate solution Sⁱ⁺¹ₖ₅ may be derived by adding the tuple (11, 3) as shown in Expression 20. Also, due to the change in neural structure, a connection may be established between the fourth neuron of the first hidden layer and the eleventh neuron of the second hidden layer, and a connection may be established between the eleventh neuron of the second hidden layer and the tenth neuron of the output layer. Therefore, Cⁱ⁺¹ₖ₅ including the weight matrices (4, 11, 1.2) and (11, 10, 0.78) may be calculated as shown in Expression 21. As a result, it is possible to acquire the varied candidate solution Sⁱ⁺¹ₖ₅ by applying the interneuron connection addition to the candidate solution Sⁱ⁺¹ₖ₄ as shown in Expression 22. Meanwhile, to distinguish between the candidate solution before the interneuron connection addition and the candidate solution after the interneuron connection addition, subscripts k4 and k5 may be used, respectively.

M_{ca}(Nⁱ⁺¹ₖ₄)=Nⁱ⁺¹ₖ₅={(1, 1); (2, 1); (3, 1); (4, 2); (5, 2); (6, 2); (11,3); (8, 3); (9, 3); (10, 4)} [Expression 20]

M_{ca}(Cⁱ⁺¹ₖ₄)=Cⁱ⁺¹ₖ₅={(1, 4, 0.5); (1, 5, -0.02); (1, 6, 2.77); (2, 4, 2.2); (3, 4, 6.2); (3, 5, 1.5); (3, 6, 0.892); (4, 11, 1.2); (4, 8, 0.05); (4, 9, 0.5); (5, 9, 2.97); (6, 8, 0.2); (6, 9, 0.56); (11, 10, 0.78); (8, 10, 0.942); (9, 10, 0.45)} [Expression 21]

Sⁱ⁺¹ₖ₄=[Nⁱ⁺¹ₖ₄, Cⁱ⁺¹ₖ₄]→Sⁱ⁺¹ₖ₅=[Nⁱ⁺¹ₖ₅, Cⁱ⁺¹_{k5]} [Expression 22]

Although a case in which a new neuron is generated due to addition of the connection between neurons existing inconsecutive layers has been described above, it is possible to apply second architecture variation for newly adding a neuron without adding any neural connection.

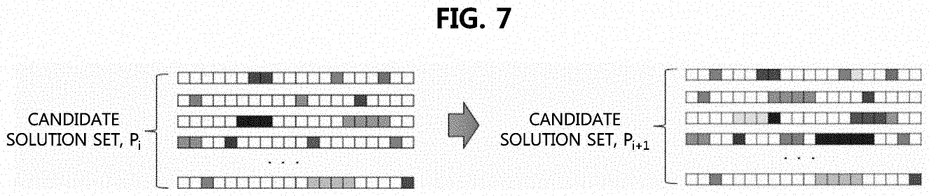

FIG. 7 is a conceptual diagram illustrating a new candidate solution set generated on the basis of candidate solutions having new features through second architecture variation.

Referring to FIG. 7, the candidate solution Sⁱ⁺¹ₖ₅ which has a varied neural structure and varied weights, that is, new features, may be acquired through the above-described second architecture variation, and the candidate solution Sⁱ⁺¹ₖ₅ may become one candidate solution constituting a new candidate solution set Pᵢ₊₁. Meanwhile, when a sufficient number of new candidate solutions are calculated, it is possible to make the new candidate solution set Pᵢ₊₁.

Also, FIG. 7 shows any candidate solutions as vectors (array) which may be represented as one-dimensional variable-length strings. Meanwhile, colors in vectors may denote that individual candidate solutions have different features in terms of structure and representation.

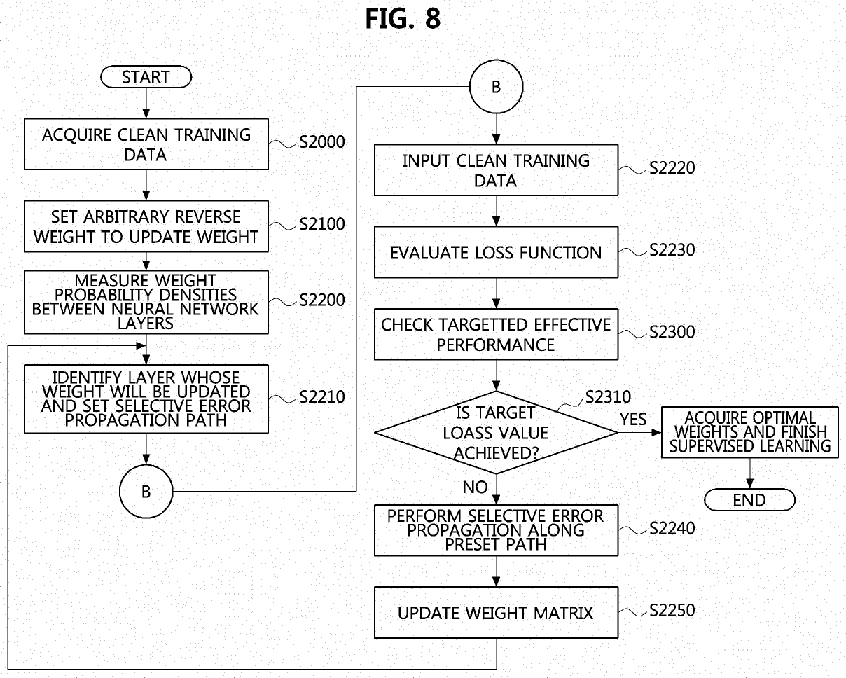

FIG. 8 is a flowchart of a selective error propagation-based supervised neural network learning method employing clean training data according to an example embodiment of the present invention.

FIG. 8 is a flowchart illustrating in detail a selective error propagation-based supervised neural network learning method employing clean training data and performed by the supervised learning section 1300 of FIG. 1 in the selective error propagation-based supervised learning operation S220 of FIG. 2.

First, a method of training a neural network according to an example embodiment of the present invention may include an operation of acquiring an optimal neural network model which has finished unsupervised learning. For example, the acquired optimal neural network model may be composed of a topology structure and weight values.

The method may also include an operation in which a target application service requests deep learning of the acquired optimal neural network model. Consequently, the target application service may request that weight values of the optimal neural network model are finely tuned.

The method may also include an operation S2000 of acquiring clean training data suitable for the inference purpose of the target application service.

The method may also include an operation S2100 of setting a pseudo reverse weight matrix, which will be used in selective error propagation, of each layer to finely update weights of the neural network model with the clean training data. Individual values of the pseudo reverse weight matrix are in a floating-point format and may be randomly initialized.

The method may also include an operation S2200 of calculating the weight density between layers of the first neural network which has finished unsupervised learning.

The weight matrix density may denote a quantitative value which relatively represents the degree of contribution toward learning of the representation of the given training data. For example, an interquartile range may be used to distinguish between layers having relatively high importance and layers having relatively low importance. Also, the average or total sum of all elements constituting a weight matrix may be used as a weight matrix density. Meanwhile, while a weight matrix density is calculated, the connection strength between layers may be calculated and contribute to distinguishing an active layer.

The method may also include an operation S2210 of identifying a layer having a relatively high density value and designating the layer as a branch point of selective error propagation. For example, a layer having a density value within top 10% may be designated as a branch point of selective error propagation. Meanwhile, in a neural network model including an input layer, a plurality of hidden layers, and an output layer in sequence, an error propagation path may be set in the direction from the output layer to the input layer.

The method may also include an operation S2220 of feed-forwarding clean training data to the neural network model and checking the results. Meanwhile, clean training data may be partitioned into specific batch units and then input. The clean training data may denote training data which provides all or only some of labels.

The method may also include an operation S2230 of calculating a loss function value by using the results which has been acquired by inputting the clean training data to the neural network model. For example, a cross-entropy error function, a mean square error function, or the like may be used as a loss function. Also, a definition function suitable for the target application service of a device for training a neural network may be used to evaluate a loss value.

The method may also include an operation S2300 of determining whether preset targeted effective performance is satisfied for supervised learning based on clean training data.

Specifically, the method may include an operation S2310 of evaluating the results, which have been acquired by inputting the clean training data to the neural network model, by using a loss function and determining whether a targeted effective loss value has been achieved. When a newly acquired loss value is smaller than or equal to the target loss value, it is determined that effective performance has been acquired. Also, when the target loss value is achieved, the neural network model satisfying the effective performance may be designated as an optimal neural network model, and then supervised learning may be finished.

The method may also include an operation S2240 of calculating an error difference value of each layer along a selective error propagation path when the target loss value has not been achieved. The error difference value may denote a value acquired by subtracting a label from an estimation value and may be an indicator representing how much a corresponding layer has relatively contributed to the error among all the layers.

The method may also include an operation S2250 of finely tuning weight matrix values between layers by using the initialized layer-specific pseudo reverse weight matrices, the set selective error propagation path, and the calculated error difference value of each layer. Once the layer-specific pseudo reverse weight matrices are initialized, the matrices may not be changed. Subsequently, the process may proceed to the operation S2200 of calculating the weight density between layers of the neural network so that neural network learning based on selective error propagation may be repeated until the target loss value is achieved.

Additionally, the method of training a neural network on the basis of selective error propagation may further improve efficiency in reducing data feature dimensions and compressing the model size by using techniques, such as quantization, binarization, and the like. Meanwhile, learning of the clean training data may be performed in a mini-batch manner, and the problem of overfitting may be solved by using a normalization technique, such as batch normalization or dropout. Also, in supervised learning, various kinds of activation functions, such as Sigmoid, Softmax, Rectified Linear Units (ReLU), Leaky ReLU, hyperbolic tangent (tanh), Exponential Linear Unit (ELU), may be used. Further, a parameter server may be additionally provided to perform a selective error propagation process in a distributed manner so that deep learning may be accelerated.

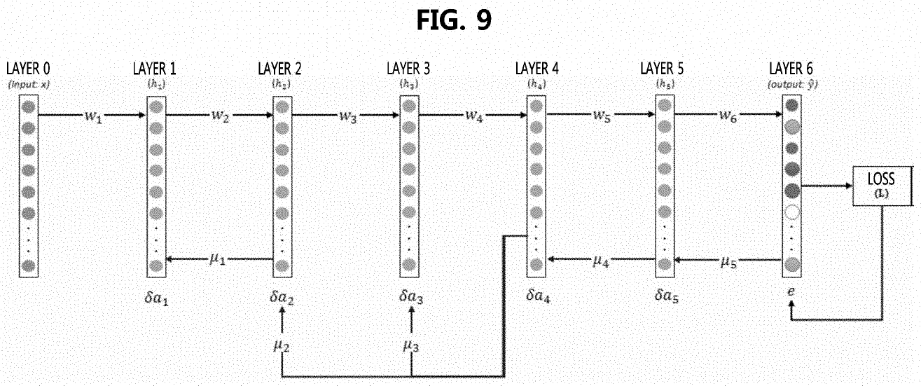

FIG. 9 is a conceptual diagram illustrating a selective error propagation-based supervised neural network learning method employing clean training data according to an example embodiment of the present invention.

Referring to FIG. 9, a neural network model includes one input layer 0, five hidden layers 1 to 5, and one output layer 6, and weight matrices w₁ to w₆ are values quantitatively representing the connection strength between neurons which exist in individual layers.

Meanwhile, a process of feed-forwarding clean training data from the input layer 0 to the first hidden layer 1 may be represented by Expression 23.

a₁=w₁x+b₁ [Expression 23]

Here, x may denote an input value acquired from the clean training data, b₁ may denote a bias value of the first hidden layer 1, and a₁ may denote an output value derived through the first hidden layer 1. Meanwhile, a final output value h₁ may be calculated as shown in

Expression 24 from the output value ai derived from each individual layer to train nonlinear data representation.

h₁=f(a₁) [Expression 24]

When input value propagation through hidden layers other than the first hidden layer 1 and the output layer 6 are represented by Expressions in the same way as the process of feed-forwarding clean training data from the input layer 0 to the first hidden layer 1, the input value propagation may be represented as the weighted sum of a previous input value, weights, and a bias value as shown in Expressions 25 to 29.

a₂=w₂h₁+b₂, h₂=f(a₂) [Expression 25]

a₃=w₃h₂+b₃, h₃=f(a₃) [Expression 26]

a₄=w₄h₃+b₄, h₄=f(a₄) [Expression 27]

a₅=w₅h₄+b₅, h₅=f(a₅) [Expression 28]

a_{y}=w₆h₅+b₆, ŷ=f(a_{y}) [Expression 29]

A final output ŷ of the output layer 6 denotes an estimation value acquired from the clean training data through the neural network and may be used to calculate an error e through a comparison with a label y. In other words, it is possible to know an error value by calculating the difference between a label and an estimation value as shown in Expression 30. Meanwhile, to evaluate the learning performance of the neural network, a loss value L may be calculated with a loss function f_{L} and an estimation value as shown in Expression 31.

e=y−ŷ [Expression 30]

L=f_{L}(\hat{y}) [Expression 31]

Meanwhile, the error e may be calculated by evaluating how much the loss value L has been changed with respect to an input value a_{y} of the activation function of the output layer as shown in Expression 32. Here, δ may denote an error difference value.

$$e = y - \hat{y} = δ {a}_{y} = \frac{\partial L}{\partial {a}_{y}} \qquad [ Expression 32 ]$$

A pseudo reverse weight matrix (μ₅, μ₄, μ₃, μ₂, μ₁), which will be used in selective error propagation from the output layer 6 to the first hidden layer 1, may be set. Also, the densities of weight matrices w₁ to w₆ may be separately calculated.

Assuming that the fourth hidden layer 4 has a relatively strong influence on the loss value L, the hidden layer 3 and the hidden layer 2 may be designated as branch points of an error propagation path for updating the weight matrices w₃ and w₄.

Meanwhile w₂ and w₅ may be updated so that an error may be simply backpropagated from a right layer to a left layer between hidden layers which have a relatively weak influence on the loss value L. Also, w₆ may be updated by a simple backpropagation from the output layer 6 to the fifth hidden layer 5 without any branch.

Also, it is possible to sequentially calculate how much the weight matrix value between individual layers from the fifth hidden layer 5 toward the first hidden layer 1 influences on the error calculated in the output layer. The layer-specific degrees of influence on the error may be defined to be error difference values δa₅, δa₄, δa₃, δa₂, and δa₁ of the corresponding layers. Consequently, the error difference values of the individual layers may be calculated as shown in Expressions 33 to 37.

First, referring to Expression 33, error propagation between the output layer and the fifth hidden layer becomes a simple backpropagation, and a result of calculating the degree of influence of the output value as of the fifth hidden layer on the error may be the error difference value δa₅ of the fifth hidden layer. Meanwhile, ⊙ may denote an element-wise multiplication operator, and f′ may denote the derivative of an activation function.

In particular, referring to Expressions 35 and 36, it is possible to see that the second and third hidden layers calculate their error difference values δa₂ and δa₃ on the basis of the error difference value δa₄ of the fourth hidden layer. Consequently, in tuning weight matrices by learning clean training data, the degrees of data representation of the weight matrices w₃ and w₄ are not adjusted on the basis of the error of the output layer, but the error difference value δa₄ of the fourth hidden layer which has been evaluated to have a strong influence on learning may be used so that accurate learning may be performed. Here, ∂ may denote a partial derivative.

$$\begin{matrix}δ {a}_{5} = \frac{\partial L}{\partial {a}_{5}} = {μ}_{5} e ⊙ {f}^{′} ( {a}_{5} ) & [ Expression 33 ] \\ δ {a}_{4} = \frac{\partial L}{\partial {a}_{4}} = {μ}_{4} δ {a}_{4} ⊙ {f}^{′} ( {a}_{4} ) & [ Expression 34 ] \\ δ {a}_{3} = \frac{\partial L}{\partial {a}_{3}} = {μ}_{3} δ {a}_{4} ⊙ {f}^{′} ( {a}_{3} ) & [ Expression 35 ] \\ δ {a}_{2} = \frac{\partial L}{\partial {a}_{2}} = {μ}_{2} δ {a}_{2} ⊙ {f}^{′} ( {a}_{2} ) & [ Expression 36 ] \\ δ {a}_{1} = \frac{\partial L}{\partial {a}_{1}} = {μ}_{1} δ {a}_{1} ⊙ {f}^{′} ( {a}_{1} ) & [ Expression 37 ]\end{matrix}$$

Update values δw₁ to δw₆ of the weight matrices w₁ to w₆ may be determined by

Expressions 38 to 43 below. Here, T may denote a transposed matrix.

$$\begin{matrix}δ {w}_{1} = \frac{\partial L}{\partial {w}_{1}} = - δ {a}_{1} {x}^{T} & [ Expression 38 ] \\ δ {w}_{2} = \frac{\partial L}{\partial {w}_{2}} = - δ {a}_{2} {h}_{1}^{T} & [ Expression 39 ] \\ δ {w}_{3} = \frac{\partial L}{\partial {w}_{3}} = - δ {a}_{3} {h}_{2}^{T} & [ Expression 40 ] \\ δ {w}_{4} = \frac{\partial L}{\partial {w}_{4}} = - δ {a}_{4} {h}_{3}^{T} & [ Expression 41 ] \\ δ {w}_{5} = \frac{\partial L}{\partial {w}_{5}} = - δ {a}_{5} {h}_{4}^{T} & [ Expression 42 ] \\ δ {w}_{6} = \frac{\partial L}{\partial {w}_{6}} = - {eh}_{5}^{T} & [ Expression 43 ]\end{matrix}$$

Subsequently, the weight matrices w₁ to w₆ may be updated as shown in Expression 44. Here, i may denote the identification number of a weight matrix, and referring to FIG. 9, i may have a value of 1 to 6. Meanwhile, η may be considered as an environmental variable which has influence on an update value of a weight matrix.

wᵢ←wᵢ+η·δwᵢ [Expression 44]

Meanwhile, processing methods related to setting of layer-specific pseudo reverse weight matrices, measurement of weight matrix densities, designation of a selective error propagation path, input of clean training data, evaluation of a loss function, selective error propagation, and update of weight matrices may be repeatedly performed until a target loss value is achieved.

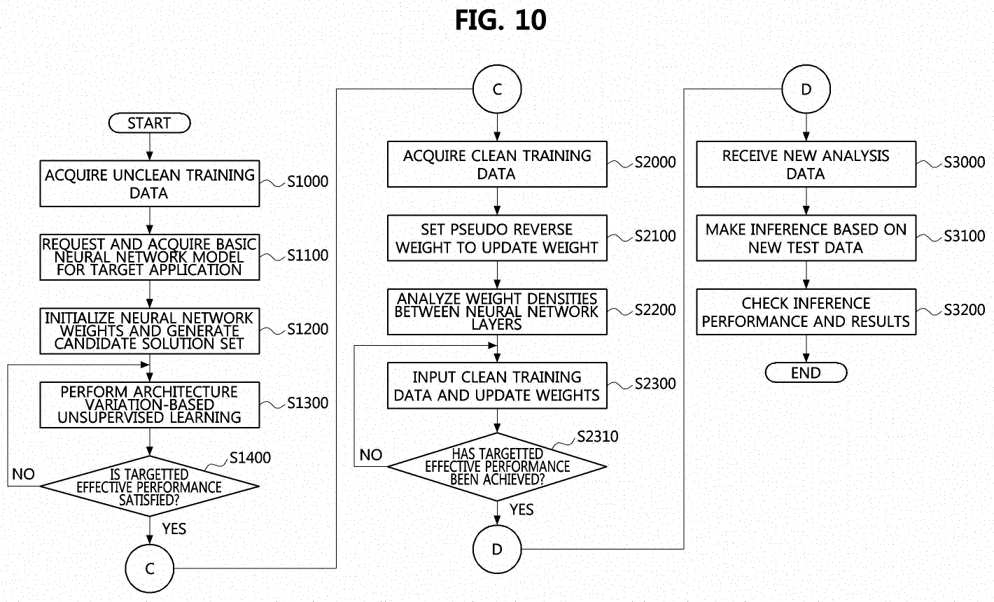

FIG. 10 is a flowchart of a method of training a neural network according to an example embodiment of the present invention.

A method of training a neural network using architecture variation-based unsupervised learning and selective error propagation-based supervised learning according to an example embodiment of the present invention may first include an operation S1000 of acquiring unclean training data in which no label is provided.

Subsequently, the method may include an operation S1100 of requesting and acquiring a basic neural network model for a target application service by using inference results based on the unclean training data. When a basic neural network model is not given, it is possible to use a small-scale neural network which is randomly generated.

Subsequently, the method may include an operation S1200 of initializing all weights of the basic neural network model and generating a plurality of varied candidate solutions by using a variable-length string schema which may represent the structure and weight values of a neural network. The plurality of generated candidate solutions may be referred to as a candidate solution set.

Subsequently, the method may include an operation S1300 of generating a different kind of candidate solution set by changing the structures and weight values of the candidate solutions through an architecture variation process and calculating a targeted effective performance indicator by inputting unclean training data to a neural network model constituted by each individual candidate solution. A set of some of the candidate solutions partitioned by a specific size or the individual candidate solutions may be processed with different computing resources.

Subsequently, the method may include an operation S1400 of determining whether there is at least one candidate solution satisfying a target performance value of a neural network training device preset for unsupervised learning with unclean training data. When there is a candidate solution satisfying the targeted effective performance of a neural network training device, a first neural network which has finished unsupervised learning may be constructed on the basis of the candidate solution. When there is no candidate solution satisfying the targeted effective performance of a neural network training device, the operation S1300 of generating a varied candidate solution set through the architecture variation process may be repeatedly performed.

The method may also include an operation S2000 of acquiring clean training data in which labels are provided.

Subsequently, the method may include an operation S2100 of setting a pseudo reverse weight which will be used in selective error propagation to finely tune second weights on the basis of supervised learning.

Subsequently, the method may include an operation S2200 of calculating weight densities between individual layers of the first neural network which has finished unsupervised learning and designating the right layer of a weight matrix having a relative high density value as a branch point of error propagation.

Subsequently, the method may include an operation of inputting clean training data and determining whether the preset targeted effective performance of the neural network training device is satisfied during supervised learning. When weight values have been updated to satisfy the targeted effective performance of the neural network training device, a second neural network which has finished supervised learning is finally acquired. On the other hand, when the weight values have not been updated to satisfy the targeted effective performance of the neural network training device, an operation S2300 of updating second weights on the basis of supervised learning may be repeatedly performed through input of the clean training data and selective error propagation.

The method may also include an operation S3000 of acquiring new test data belonging to a domain which is identical or similar to the domain of the unclean training data and the clean training data. Subsequently, the method may include an operation S3100 of making a type of inference required by the target application service by using the new test data and the acquired second neural network. Subsequently, the method may include an operation S3200 of acquiring and checking inference results and an indicator of inference performance.

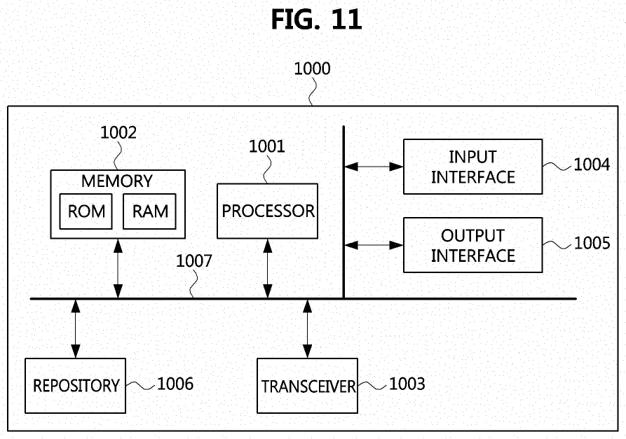

FIG. 11 is a block diagram of a device for training a neural network according to another example embodiment of the present invention.

A device 1000 for training a neural network according to an example embodiment of the present invention may include at least one processor 1001, a memory 1002 which stores at least one command executed by the processor 1001, and a transceiver 1003 which is connected to a network to perform communication.

The device 1000 for training a neural network may further include an input interface 1004, an output interface 1005, a repository 1006, and the like. The elements included in the device 1000 for training a neural network may be connected through a bus 1007 and communicate with each other.

The processor 1001 may execute program commands stored in at least one of the memory 1002 and the repository 1006. The processor 1001 may be a CPU, a GPU, or a dedicated processor whereby methods according to example embodiments of the present invention are performed. Each of the memory 1002 and the repository 1006 may be configured with at least one of a volatile storage medium and a non-volatile storage medium. For example, the memory 1002 may be configured with at least one of a read-only memory (ROM) and a random access memory (RAM).

The repository 1006 may also store an optimal neural network model which is generated as a result of unsupervised learning and an optimal neural network model which is generated as a result of supervised learning.

The at least one command may include a command for generating a candidate solution set by modifying a candidate solution which represents a basic neural network model in a variable-length string form, a command for acquiring first candidate solutions by performing architecture variation-based unsupervised learning with a plurality of candidate solutions selected from the candidate solution set, a command for selecting a neural network model represented by a first candidate solution which satisfies targeted effective performance as a first neural network model, a command for acquiring second candidate solutions by performing selective error propagation-based supervised learning with the first neural network model, and a command for selecting a neural network model represented by a second candidate solution which satisfies the targeted effective performance as a final neural network model.

In this case, the candidate solution which represents the basic neural network model in a variable-length string form may include weight matrices which represent neural interconnections and weights related to connection strengths between neurons and a matrix representing a neural network structure.

The command for acquiring the first candidate solutions by performing architecture variation-based unsupervised learning with the plurality of candidate solutions selected from the candidate solution set may perform architecture variation-based unsupervised learning in parallel on the basis of the DOP.

The command for acquiring the first candidate solutions by performing architecture variation-based unsupervised learning with the plurality of candidate solutions selected from the candidate solution set may include a command for acquiring the first candidate solutions by merging two candidate solutions in the candidate solution set.

The command for acquiring the first candidate solutions by performing architecture variation-based unsupervised learning with the plurality of candidate solutions selected from the candidate solution set may include a command for acquiring the first candidate solutions by performing at least one architecture variation method among weight modification, interneuron connection removal, interneuron connection addition, neuron removal, and neuron addition.

The command for acquiring the second candidate solutions by performing selective error propagation-based supervised learning with the first neural network model may include a command for setting a pseudo reverse weight matrix to finely tune weight matrices.

The command for acquiring the second candidate solutions by performing selective error propagation-based supervised learning with the first neural network model may include a command for analyzing weight matrix densities of the first neural network model and setting the path of selective error propagation-based supervised learning.

In this case, the command for analyzing the weight matrix densities of the first neural network model and setting the path of selective error propagation-based supervised learning may include a command for analyzing the weight matrix densities by using an interquartile range.

The command for analyzing the weight matrix densities of the first neural network model and setting the path of selective error propagation-based supervised learning may include a command for analyzing the weight matrix densities by using the average or total sum of weights constituting weight matrices.

The command for analyzing the weight matrix densities of the first neural network model and setting the path of selective error propagation-based supervised learning may include a command for updating weight matrices on the basis of error difference values of the first neural network model extracted along the path of selective error propagation-based supervised learning.

Meanwhile, a target application service may be executed by the processor 1001 and may be assumed to involve a data inference function. The term “processor” may denote a computing device which is physically adjacent to a raw data source or a terminal device capable of acquiring raw data. Consequently, the processor may rapidly acquire and analyze data compared with external computing devices located at long distances.

The processor 1001 may download a basic neural network model suitable for inference in a corresponding data domain by requesting the basic neural network model from the transceiver 1003, encode the basic neural network model into a variable-length string in a one-dimensional vector form, and then generate a plurality of candidate solutions by making structural or numerical modifications to constitute an initial candidate solution set.

The initial candidate solution set may be partitioned into subsets of a certain size and transferred to a processor set, and each processor may generate a new candidate solution set which may have excellent data representation by applying first and second architecture variation methods to the initial candidate solution set. Also, the newly generated candidate solution set may be collected and evaluated by the processor.

Meanwhile, the present invention is repeatedly performed to generate a candidate solution set until preset targeted effective performance is satisfied, and the processor may finally acquire a neural network model which has finished architecture variation-based unsupervised learning as an optimal solution. Also, when new data in which no label is provided is acquired, the target application service may rapidly make a coarse-grained inference by using the optimal solution which has finished architecture variation-based unsupervised learning. Unsupervised parallel learning may be performed in an onloading manner by only using the processor.

The processor transfers the neural network model which has been encoded as an optimal solution to the transceiver. When clean training data including labels is acquired through the processor, the transceiver may perform selective error propagation-based supervised learning to finely tune weights and finally calculate a neural network model. Meanwhile, selective error propagation-based supervised learning may be performed in an offloading manner with the help of computing power.

The neural network model which has finished selective error propagation-based supervised learning may be distributed to processors so that the processors may make fine-grained inferences from newly acquired training data. Consequently, the target application service may acquire appropriate data analysis results.

Neural network learning including both architecture variation-based unsupervised learning and selective error propagation-based supervised learning may be performed through the transceiver. Also, all learning processes may be performed through cooperation among processors.

A method of training a neural network using architecture variation-based unsupervised learning and selective error propagation-based supervised learning according to an example embodiment of the present invention makes it possible to ensure the consistency of data information by performing unsupervised learning based on architecture variation. In other words, as a preprocessing operation for learning deep representation of training data, it is possible to learn major features of unclean training data in which labels are not included. Therefore, data clustering, outlier removal, and dimension reduction are possible.

Also, the method makes it possible to accelerate learning and optimize a neural network structure by performing unsupervised learning based on architecture variation. In other words, it is possible to accelerate learning by training neural network models in parallel and to train neural networks to represent features of unclean training data as a neural network structure as well as weights.

The method of training a neural network using architecture variation-based unsupervised learning and selective error propagation-based supervised learning according to an example embodiment of the present invention makes it possible to lighten the computation of supervised learning by performing supervised learning based on selective error propagation. In other words, when clean training data including labels is given, weight matrix values which have significant influence on learning errors are first applied to learning to update a weight matrix. Consequently, the method may contribute to lightening of the computation of supervised learning and also improve the accuracy of learning.

Methods according to example embodiments of the present invention may be implemented in the form of program commands which can be executed by various computing means and recorded in a computer-readable medium. The computer-readable medium may include program commands, data files, data structures, etc. solely or in combination. Program commands recorded in the computer-readable medium may be specially designed and configured for the present invention or well known to and available by those of ordinary skill in the computer software field.

Examples of the computer-readable medium may include a hardware device specially configured to store and execute program commands, such as a ROM, a RAM, a flash memory, and the like. Examples of the program commands may include not only a machine language code generated by a compiler but also a high level language code that may be executed by a computer by means of an interpreter or the like. The hardware device may be configured to operate as at least one software module for performing operations of the present invention, or vice versa.

Some or all of elements of the above-described method or device may be implemented in combination or separately.

While the exemplary embodiments of the present invention have been described above, those of ordinary skill in the art should understand that various changes, substitutions and alterations may be made herein without departing from the spirit and scope of the present invention as defined by the following claims.

What is claimed is:

1. A method of training a neural network, the method comprising:
generating a candidate solution set by modifying a candidate solution which represents a basic neural network model in a variable-length string form;
acquiring first candidate solutions by performing architecture variation-based unsupervised learning with a plurality of candidate solutions selected from the candidate solution set;
selecting a neural network model represented by a first candidate solution, which satisfies targeted effective performance, as a first neural network model;
acquiring second candidate solutions by performing selective error propagation-based supervised learning with the first neural network model; and
selecting a neural network model represented by a second candidate solution, which satisfies the targeted effective performance, as a final neural network model.

2. The method of claim 1, wherein the candidate solution, which represents the basic neural network model in a variable-length string form, includes weight matrices, which represent neural interconnections and weights related to connection strengths between neurons, and a matrix representing a neural network structure.

3. The method of claim 1, wherein the acquiring of the first candidate solutions by performing architecture variation-based unsupervised learning with the plurality of candidate solutions selected from the candidate solution set comprises performing architecture variation-based unsupervised learning in parallel on the basis of degree of parallelism (DOP).

4. The method of claim 1, wherein the acquiring of the first candidate solutions by performing architecture variation-based unsupervised learning with the plurality of candidate solutions selected from the candidate solution set comprises acquiring the first candidate solutions by merging two candidate solutions in the candidate solution set.

5. The method of claim 1, wherein the acquiring of the first candidate solutions by performing architecture variation-based unsupervised learning with the plurality of candidate solutions selected from the candidate solution set comprises acquiring the first candidate solutions by performing at least one architecture variation method among weight modification, interneuron connection removal, interneuron connection addition, neuron removal, and neuron addition.

6. The method of claim 1, wherein the acquiring of the second candidate solutions by performing selective error propagation-based supervised learning with the first neural network model comprises setting a pseudo reverse weight matrix to finely tune weight matrices.

7. The method of claim 1, wherein the acquiring of the second candidate solutions by performing selective error propagation-based supervised learning with the first neural network model comprises analyzing weight matrix densities of the first neural network model and setting a path of selective error propagation-based supervised learning.

8. The method of claim 7, wherein the analyzing of the weight matrix densities of the first neural network model and setting of the path of selective error propagation-based supervised learning comprise analyzing the weight matrix densities by using an interquartile range.

9. The method of claim 7, wherein the analyzing of the weight matrix densities of the first neural network model and setting of the path of selective error propagation-based supervised learning comprise analyzing the weight matrix densities by using an average or total sum of weights constituting weight matrices.

10. The method of claim 7, wherein the analyzing of the weight matrix densities of the first neural network model and setting of the path of selective error propagation-based supervised learning comprise updating weight matrices on the basis of error difference values of the first neural network model extracted along the path of selective error propagation-based supervised learning.

11. A device for training a neural network, the device comprising:
a processor; and
a memory configured to store at least one command executed through the processor,
wherein the at least one command comprises:
a command for generating a candidate solution set by modifying a candidate solution which represents a basic neural network model in a variable-length string form;
a command for acquiring first candidate solutions by performing architecture variation-based unsupervised learning with a plurality of candidate solutions selected from the candidate solution set;
a command for selecting a neural network model represented by a first candidate solution, which satisfies targeted effective performance, as a first neural network model;
a command for acquiring second candidate solutions by performing selective error propagation-based supervised learning with the first neural network model; and
a command for selecting a neural network model represented by a second candidate solution, which satisfies the targeted effective performance, as a final neural network model.

12. The device of claim 11, wherein the candidate solution, which represents the basic neural network model in a variable-length string form, includes weight matrices, which represent neural interconnections and weights related to connection strengths between neurons, and a matrix representing a neural network structure.

13. The device of claim 11, wherein the command for acquiring the first candidate solutions by performing architecture variation-based unsupervised learning with the plurality of candidate solutions selected from the candidate solution set comprises a command for performing architecture variation-based unsupervised learning in parallel on the basis of degree of parallelism (DOP).

14. The device of claim 11, wherein the command for acquiring the first candidate solutions by performing architecture variation-based unsupervised learning with the plurality of candidate solutions selected from the candidate solution set comprises a command for acquiring the first candidate solution by merging two candidate solutions in the candidate solution set.

15. The device of claim 11, wherein the command for acquiring the first candidate solutions by performing architecture variation-based unsupervised learning with the plurality of candidate solutions selected from the candidate solution set comprises a command for acquiring the first candidate solutions by performing at least one architecture variation method among weight modification, interneuron connection removal, interneuron connection addition, neuron removal, and neuron addition.

16. The device of claim 11, wherein the command for acquiring the second candidate solutions by performing selective error propagation-based supervised learning with the first neural network model comprises a command for setting a pseudo reverse weight matrix to finely tune weight matrices.

17. The device of claim 11, wherein the command for acquiring the second candidate solutions by performing selective error propagation-based supervised learning with the first neural network model comprises a command for analyzing weight matrix densities of the first neural network model and setting a path of selective error propagation-based supervised learning.

18. The device of claim 17, wherein the command for analyzing the weight matrix densities of the first neural network model and setting the path of selective error propagation-based supervised learning comprises a command for analyzing the weight matrix densities by using an interquartile range.

19. The device of claim 17, wherein the command for analyzing the weight matrix densities of the first neural network model and setting the path of selective error propagation-based supervised learning comprises a command for analyzing the weight matrix densities by using an average or total sum of weights constituting weight matrices.

20. The device of claim 17, wherein the command for analyzing the weight matrix densities of the first neural network model and setting the path of selective error propagation-based supervised learning comprises a command for updating weight matrices on the basis of error difference values of the first neural network model extracted along the path of selective error propagation-based supervised learning.
